(19) United States
(12) Patent Application Publication
(10) Pub. No.: US 2002/0119744 A1
(43) Pub. Date: Aug. 29, 2002

(54) Saving box

(76) Inventor: Suk Kwak, Seoul (KR)

Correspondence Address: McGuire Woods, Suite 1800, 1750 Tysons Boulevard, Tysons Corner, McLean, VA, 22102-4215, US

(21) Appl. No.: 10/073,002

(22) Filed: Feb. 12, 2002

(30) Foreign Application Priority Data
Feb. 24, 2001 (KR) 2001-0009445
Sep. 29, 2001 (KR) 2001-0060989
Sep. 29, 2001 (KR) 2001-0060990

(51) Int. Cl. G07D 1/06

(52) U.S. Cl. 453/1

(57) ABSTRACT

A saving box is disclosed, which senses an amount of a coin in accordance with the size of the coin thrown in the saving box and automatically releases a locking unit in accordance with the sensed amount. To this end, an electrical contact node is installed in a rotating lever, and a plurality of another contact nodes are installed to electrically connect with the contact node of the lever in accordance with a rotational angle. Thus, the number of coins thrown in the saving box can be checked by a simple mechanism. At the same time, the amount of the coins can be sensed by load of the coins after the coins pass through the lever.

### BACKGROUND OF THE INVENTION

1. Field of the Invention

The present invention relates to a saving box, and more particularly, to a saving box that senses an amount of a coin in accordance with the size of the coin thrown in the saving box and automatically releases a locking unit in accordance with the sensed amount.

2. Discussion of the Related Art

Generally, there are various types of saving boxes. Of them, a piggy box manufactured by ejecting plastic in a pig shape is being commercially sold. The piggy box with a closed type pig shape has a slot at a top surface to insert a coin therein. Such a piggy box is configured so that coins are drawn out therefrom by cutting a portion using a cutting tool such as knife when a user intends to draw out the coins in the piggy box. This piggy box has a drawback in that the piggy box cannot be recycled after the coins are drawn out from the piggy box. Similarly, there is an iron saving box of metal material. In the same manner as the piggy box, the iron saving box includes a coin slot at a top surface and a hole formed at a bottom surface to draw out coins. The hole is tightly fitted into a cover. The iron saving box can be recycled by fitting the cover into the hole after the coins are drawn out by opening the cover. However, in this case, since the user can freely draw out the coins, it is difficult to implant a propensity to save in children's mind.

To solve such a problem, as shown in FIG. 1, there is provided another related art saving box. Referring to FIG. 1, a coin slot 100a is formed at a top portion of a cylindrical saving box 100 to insert coins 120 therein. A door 110 is hinge coupled to a lower portion of the saving box 100 so that the coins 120 saved in the saving box 100 can be drawn out if the door 110 is opened. A locking unit 111 is connected to the door 110 to control opening and shutting of the door 110, and a controller 112 is installed at the rear of the locking unit 111 to control the operation of the locking unit 111. The controller 112 is connected to a counter 130 and a display unit 114. The counter 130 is installed below the coin slot 100a to sense the number of coins drawn in the saving box, calculate an amount of the coins, and output a signal indicative of the calculated amount. The display unit 114 receives the signal from the counter 130 and displays the amount saved in the saving box 100. A liquid crystal display (LCD) is generally used as the display unit 114. The controller 112 is connected to an input unit 113 installed below the display unit 114. The input unit 113 includes a number of buttons to allow a user to input a target amount of coins which will be drawn in the saving box 100. Therefore, once the user inputs the target amount in the input unit 113, the input signal is input to the controller 112 so that the controller 112 compares the target amount with an accumulated amount saved in the saving box 100 to control the locking unit 111, thereby controlling opening and shutting of the door 110.

Meanwhile, the counter 130 can sense the amount of the coins 120 inserted through the coin slot 100a by sensing either weight of the coins 120 or their sizes. The above elements of the saving box 100 are electrically operated by a power supply (not shown).

However, the aforementioned related art saving box has several problems.

In the case that a sensor is used as the counter required to exactly carry out a function of the saving box, a problem arises in that the cost increases. Also, in the case that the counter is configured to sense the sizes of the coins, the counter has a complicated structure, thereby increasing the cost.

### SUMMARY OF THE INVENTION

Accordingly, the present invention is directed to a saving box that substantially obviates one or more of the problems due to limitations and disadvantages of the related art.

An object of the present invention is to provide a saving box that can sense the size of a coin by means of a simple mechanism and automatically release a locking unit in accordance with the sensed result.

Additional features and advantages of the invention will be set forth in the description which follows, and in part will be apparent from the description, or may be learned by practice of the invention. The objectives and other advantages of the invention will be realized and attained by the scheme particularly pointed out in the written description and claims hereof as well as the appended drawings.

To achieve these and other advantages and in accordance with the purpose of the present invention, as embodied and broadly described, in a saving box which senses an amount of coins inserted in a coin slot and accumulatively calculates the amount of the coins so that a controller automatically opens a door to drawn out the coins if the accumulated amount reaches a target amount, the saving box includes: a guide means connected to the coin slot to guide the coins descending by tare; a lever guided by the guide means and rotated by load of the descending coins, having a first terminal electrically connected to the controller; a plurality of second terminals electrically connected to the first terminal of the lever as the lever rotates and electrically connected to the controller; and an elastic means providing restoring force to allow the lever to return to its original position after the lever rotates.

The saving box further includes a sensor connected to the controller to sense whether the coins have completely passed through the lever.

The saving box further includes a catcher installed in a case, a bolt installed in the door and linearly driven to be caught in the catcher, an elastic means which provides elasticity to pull the bolt in an opposite direction of the catcher, and a fixed means fixing the bolt in a state that the bolt is caught in the catcher.

It is to be understood that both the foregoing general description and the following detailed description are exemplary and explanatory and are intended to provide further explanation of the invention as claimed.

### BRIEF DESCRIPTION OF THE ATTACHED DRAWINGS

The invention will be described in detail with reference to the following drawings in which like reference numerals refer to like elements wherein:

FIG. 1 is a perspective view of a related art saving box;

FIG. 2 is a perspective view of a saving box according to the present invention;

FIG. 3 is an exploded perspective view of a saving box according to the present invention;

FIG. 4 is a front view of a coin counter which is a part of the saving box according to the present invention;

FIG. 5 is a side view of a coin counter which is a part of the saving box according to the present invention;

FIG. 6 is a perspective view illustrating a state before a coin is inserted in a coin counter of a saving box according to the present invention;

FIG. 7 is a perspective view illustrating a state that a coin is being inserted in a coin counter of a saving box according to the present invention;

FIG. 8 is a perspective view illustrating a state that a coin is completely inserted in a coin counter of a saving box according to the present invention;

FIG. 9 is a front view illustrating a state that a locking unit of a saving box according to the first embodiment of the present invention is locked;

FIG. 10 is a front view illustrating a state that a locking unit of a saving box according to the second embodiment of the present invention is opened;

FIG. 11 is a perspective view illustrating an initial state that a coin is inserted in a coin counter of a saving box according to the second embodiment of the present invention;

FIG. 12 is a perspective view illustrating an intermediate state that a coin is inserted in a coin counter of a saving box according to the second embodiment of the present invention;

FIG. 13 is a perspective view illustrating a final state that a coin is inserted in a coin counter of a saving box according to the second embodiment of the present invention;

FIG. 14 is a front view of a PCB at the initial state of FIG. 11;

FIG. 15 is a front view of a PCB at the intermediate state of FIG. 12;

FIG. 16 is a front view of a PCB at the final state of FIG. 13; and

FIG. 17 is a front view of a coin counter at the initial state of FIG. 11.

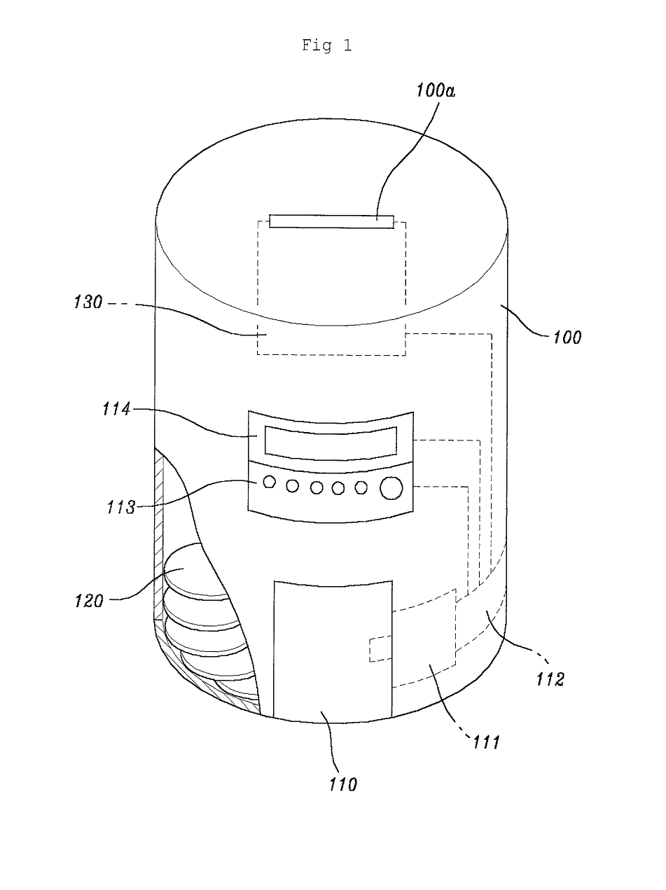

### DETAILED DESCRIPTION OF THE PREFERRED EMBODIMENTS

Reference will now be made in detail to the preferred embodiments of the present invention, examples of which are illustrated in the accompanying drawings.

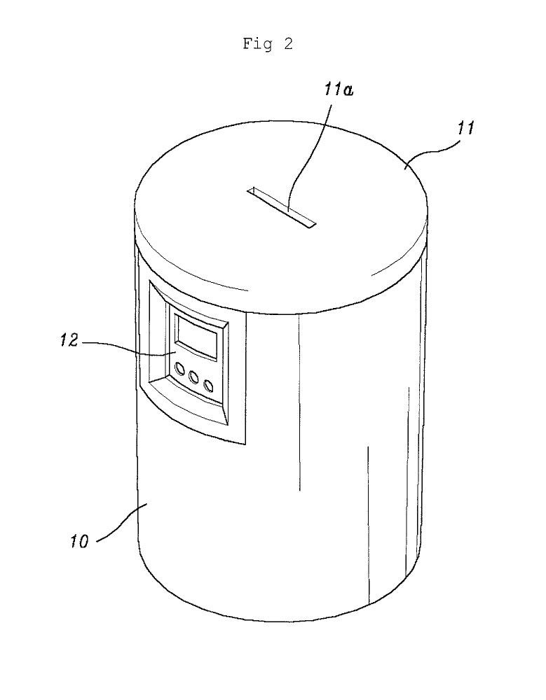

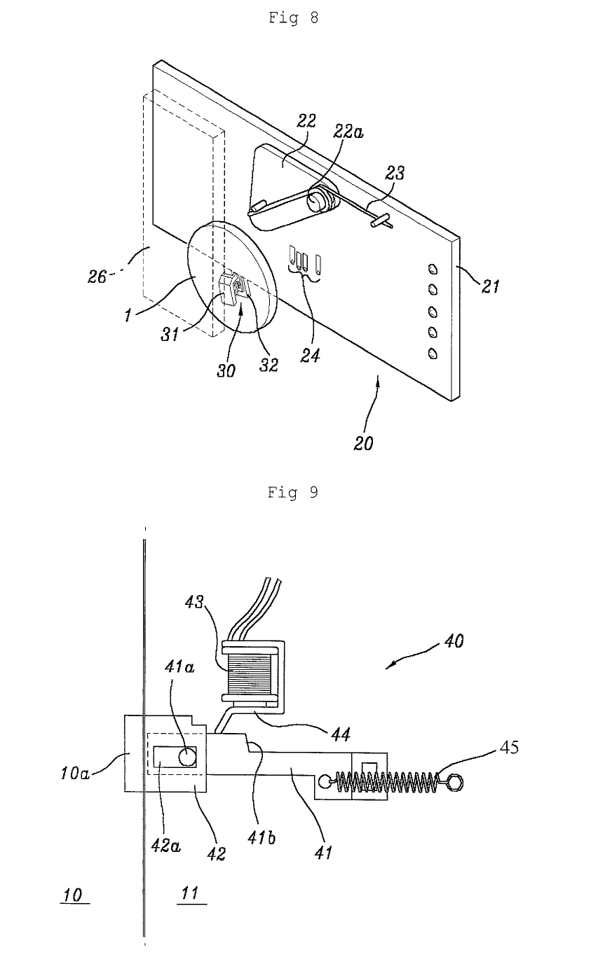

As shown in FIGS. 2 to 10, a saving box according to the first embodiment of the present invention includes a case 10, a lid door 11, a coin counter 20, and a checking unit 30. A coin 1 is received in the case 10. The lid door 11 is fixed to a top portion of the case 10 and includes a coin slot, 11a, a controller 12, and a locking unit 40. The controller 12 is installed at the front and is connected to a display unit and an input unit while the locking unit 40 is installed at the rear. The coin counter 20 is installed at a lower portion of the coin slot 11a of the lid door 11 to sense the size of the coin 1 and output the sensed signal to the controller 12. The checking unit 30 is installed at a lower portion of the coin counter 20 to check whether the coin 1 has been completely drawn in the saving box.

The display unit connected to the controller 12 displays time and various information as well as a current amount of coins 1 drawn in the saving box or the number of the coins 1. The input unit can be used to input a target amount or to adjust the time. In addition, various information may be input to the input unit.

The locking unit 40 installed at the rear of the lid door 11 is connected to the controller 20, so that the locking state is released in accordance with a signal of the controller 12. That is, if the amount of the coins accumulated in the saving box reaches a certain amount, the controller 12 outputs the signal to release the locking unit 40, thereby opening the lid door 11. Likewise, if the number of the coins 1 reaches a certain number, the locking unit 40 can be released to open the lid door 11.

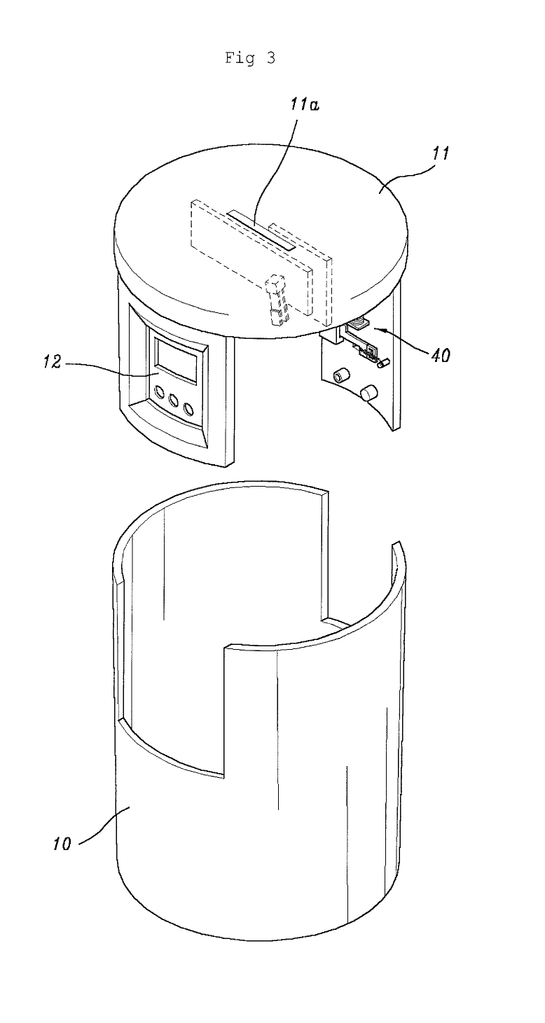

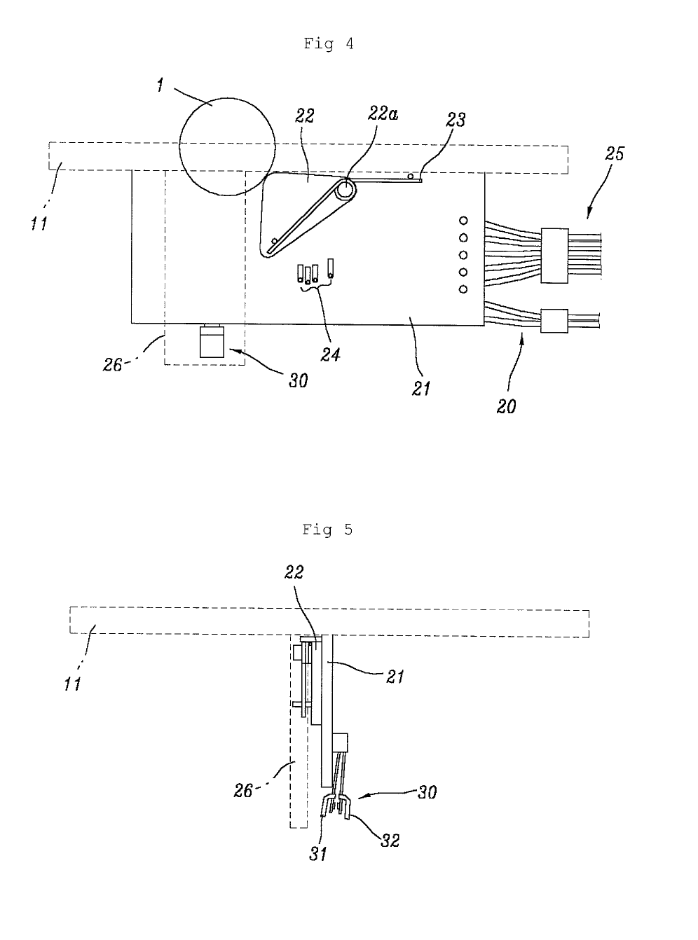

The coin counter 20, as shown in FIGS. 4 to 8, includes a PCB 21 vertically installed at the rear below the coin slot 11a, a guide 26 installed at the front below the coin slot 11a to guide the coin 1 drawn in the saving box, together with the PCB 21, a lever 22 rotating around a rotary shaft 22a installed at one side of the PCB 21 as it is pushed by the coin 1 drawn in the saving box, and a torsion spring 23 providing elasticity to restore the lever 22 to its original position after the coin 1 is drawn in the saving box. The PCB 21 includes a plurality of contact nodes 24 coupled to the lever 22 in accordance with a rotational angle of the lever 22. The contact nodes 23 and the lever 22 are electrically connected to the controller 12 by a cable 25, so that the controller 12 senses the size of the coin 1 in accordance with the rotational angle of the lever 22, thereby sensing the number of the coins 1 and their amount. That is to say, as shown in FIG. 3, the number of the contact nodes 24 is four, so that the controller 12 senses the amount of the coins in the order of 50 won, 10 won, 100 won, and 500 won in accordance with the contact order between the contact nodes and the lever 22 as the lever 22 rotates.

The checking unit 30 that checks insertion of the coin 1, as shown in FIGS. 4 to 8, includes a first contact node 31 pushed by the coin to move to the rear if the coin 1 is inserted into the saving box, and a second contact node 32 usually separated from the first contact node 31 and contacted the first contact node 31 when the first contact node 31 is pushed by the coin 1 to move to the rear. The first and second contact nodes 31 and 32 are connected to the controller 12 so that the controller 12 exactly determines whether the coin 1 has been inserted in the saving box. That is, even in case where the amount of the coin calculated by the coin counter 20 is sensed by the controller 12, the controller 12 does not add the coin 1 to the accumulated amount unless insertion of the coin is completely checked by the checking unit 30. Preferably, the checking unit 30 is far away from the coin slot 11a at a greater distance than the size of the coin 1.

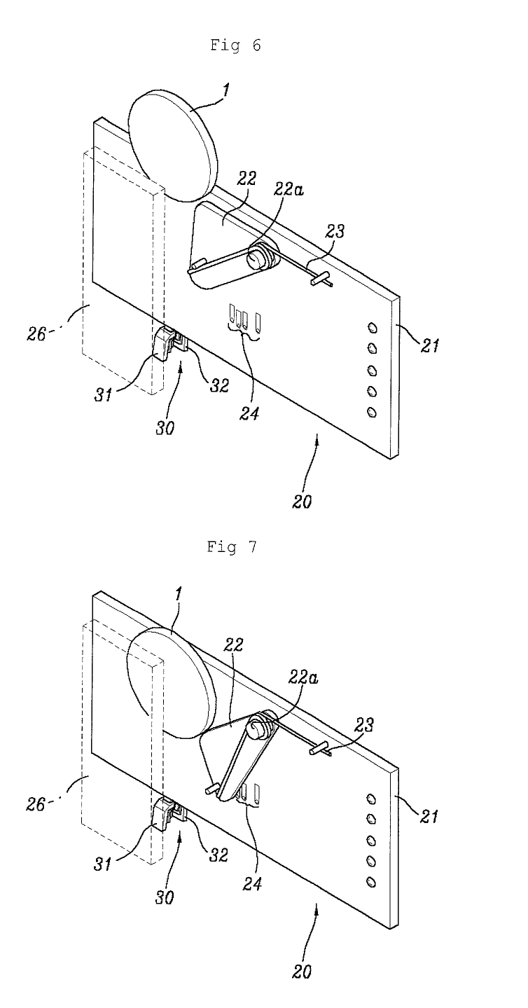

In the first embodiment of the present invention, the user inputs a target amount to be saved in the saving box in the input unit. Once the target amount is input to the input unit, the user can set a password in the input unit to prevent the target amount from being input to the input unit again. After the target amount is input to the input unit, the user inserts the coins 1 in the saving box for a certain time until the coins 1 reach the target amount. As shown in FIG. 5, before the coin 1 is inserted in the saving box, the lever 22 is not rotated. As shown in FIG. 6, once the coin 1 starts to be inserted in the saving box, the coin 1 is downwardly inserted in the saving box under the guide of the guide 26, the PCB 21, and the lever 22. At this time, the lever 22 is rotated by being pushed by the coin 1. A rotational angle of the lever 22 is determined to correspond to the size of the coin 1, and the signal from the contact node finally coupled to the lever 22 is input to the controller 12 so that the controller 12 senses the size of the coin 1 and at the same time senses the amount of the coin 1. Once the coin 1 passes through the lever 22, as shown in FIG. 7, the coin 1 is completely inserted into the case 10 of the saving box while pushing the first contact node 31. At this time, the first contact node 31 is coupled to the second contact node 32 and input to the controller 12 as an output signal. Thus, the controller 12 adds the amount of the sensed coin 1 to the accumulated amount. Once the accumulated amount is increased by insertion of the coin to exceed the input target amount, the controller 12 outputs the signal to the locking unit 40 to open the lid door 11 and at the same time generates buzzer or melody sound to inform the user that the target amount is saved in the saving box. If the user inputs the target amount too much, the locking unit 40 may not be released even in case where a space for the coins 1 is formed no longer as the coins 1 are accumulated in the case 10. Therefore, it is preferable that the controller 12 is programmed to automatically open the lid door 11 in case of a certain number of the coins 1.

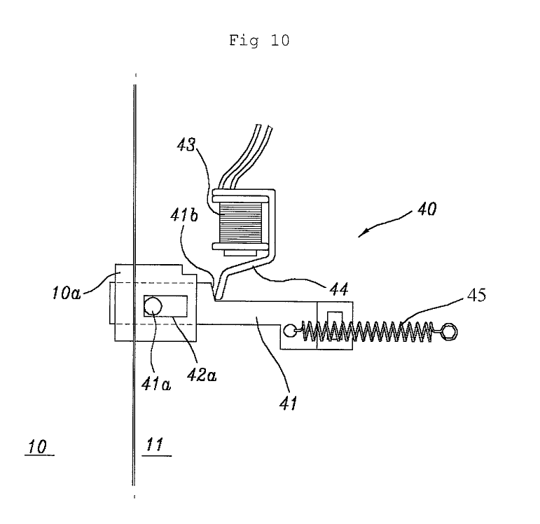

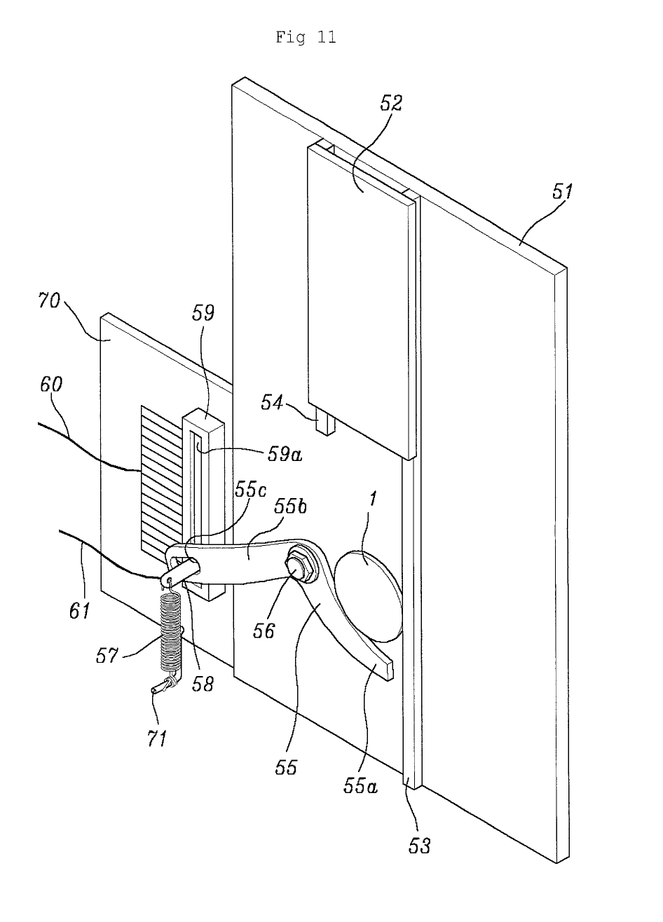

Furthermore, the locking unit 40 of the saving box according to the first embodiment of the present invention, as shown in FIGS. 9 and 10, includes a catcher 10a installed at the rear of the case 10, a bolt 41 linearly driven to be caught in the catcher 10a, a tension spring 45 which provides elasticity to backwardly pull the bolt 41 all the time, a hanging member 44 hung in a step portion 41b formed at one side of the bolt 41 to restrict movement of the bolt 41 to the rear, thereby maintaining the locking state, and an electromagnet 43 upwardly pulling the hanging member 44 by means of magnetic force to release the hanging state of the bolt 41. A projection 41a is formed at the front of the bolt 41 and is fitted into a slot 42a of a guide 42 which guides movement of the bolt 41. Since the hanging member 44 is configured to downwardly receive elasticity as shown in FIG. 9, the locking state is released if the hanging member 44 is upwardly pulled by the electromagnet 43 at the locking state. The hanging member 44 should be made of a magnetized material that can move by means of magnetic force.

FIG. 9 illustrates a state that the bolt 41 is caught in the catcher 10a.

Referring to FIG. 9, since no power is supplied to the electromagnet 43, the hanging member 44 downwardly descends by its elasticity and is caught in the step portion 41b of the bolt 41. The bolt 41 moves by departing from the elasticity of the tension spring 45, so that its front portion is fitted into the catcher 10a. Therefore, the lid door 11 is in the locking state. This is because that the user pushes a portion (not shown) of the bolt 41 exposed to the outside of the lid door 11 in a state that the lid door 11 is fixed to the case 10.

FIG. 10 is a front view illustrating a state that the locking state of the locking unit 40 is released.

Referring to FIG. 10, the power is supplied to the electromagnet 43, so that the hanging member 44 is stuck to the electromagnet 43. The hanging member 44 is released from the step portion 41b of the bolt 41 so that the bolt 41 backwardly moves by means of the elasticity of the tension spring 45. Therefore, the front of the bolt 41 is released from the catcher 10a, and the lid door 11 can be separated from the case 10. That is, the user inputs a certain target amount to the input unit connected with the controller 12, fixes the lid door 11 to the case 10, and pushes the bolt 41 to maintain the locking state. Then, the user continues to insert the coins 1 to reach the target amount. Once the target amount is saved in the saving box, the controller 12 outputs a signal so that the power is supplied to the electromagnet 43, thereby releasing the bolt 41 from the catcher 10a.

Meanwhile, a coin counter according to the second embodiment of the present invention, as shown in FIGS. 11 to 17, includes a main panel 51 attached to a saving box 1, two guide rods 53 and 54 attached to the main panel 51 to guide a coin 1 inserted through a coin slot 1a, and a cover panel 52 for guiding the coin 1 together with the two guide rods 53 and 54 and the main panel 51. The above elements serve to guide the coin 1 inserted in the saving box 1.

The coin counter according to the second embodiment of the present invention further includes a lever 55 rotated by weight of the coin 1. The lever 55 includes a first arm 55a, a rotary shaft 56, and a second arm 55b. The first arm 55a has a middle portion rotatably installed with respect to the main panel 51, so that the coin 1 descends around the rotary shaft 56. The second arm 55b is disposed at an opposite side of the first arm 55a and rotated at the same angle as that of the first arm 55a.

The lever 55 is configured such that the coin 1 is caught in the first arm 55a and a long slot 55c is formed in the second arm 55b. Once the coin 1 is placed in the first arm 55a, the lever 55 is rotated clockwise by weight of the coin 1 so that the first arm 55a descends together with the coin 1 while the second arm 55b ascends. The first arm 55a is upwardly bent in a round shape so as to reduce impact due to the weight of the coin 1.

In the aforementioned coin counter, the lever 55 is rotated as the coin 1 descends. As a result, the second arm 55b of the lever 55 moves upwardly, so that a first terminal 58a is connected with a cable 61. The first terminal 58a is fitted into the slot 55c formed in the second arm 55b and performs a straight-line motion up and down. Also, the first terminal 58a is connected with the cable 61 through a rod 58 fitted into the slot 55c. A guide cover 59 having a longitudinal slot 59a is uprightly installed in a printed circuit board (PCB) 70 connected to the main panel 51 so as to guide the rod 58 in an up and down straight-line direction. Therefore, the rod 58 moves up and down in a straight-line direction under the guide of the slot 59a of the guide cover 59. The first terminal 58 moves in a straight-line direction accordingly. Furthermore, a plurality of second terminals 60a are installed in the PCB 70 at constant intervals and are connected to a cable 60. Each of the second terminals is repeatedly turned on/off as the first terminal 58a moves up and down. A spring 57 is connected to one end of the rod 58. One end of the spring 57 is fixed to a fixed member 71 fixed to one side of the PCB 70. Therefore, after the lever 55 is rotated by weight of the coin 1, the lever 55 returns to its original position by means of elasticity of the spring 57.

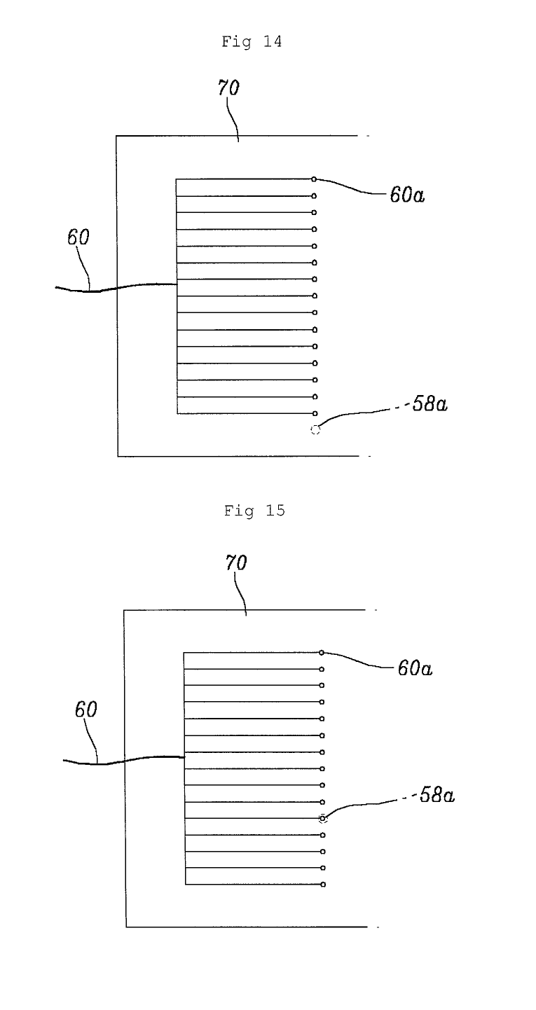

Once the coin 1 passes through the coin slot 1a of the saving box 1 as shown in FIG. 2, the coin 1 moves downwardly by passing through the main panel 51, the cover panel 52, and the two guide rods 53 and 54 as shown in FIGS. 11 and 17. The coin 1 is caught on the first arm 55a of the lever 55. At this time, since the first arm 55a of the lever 55 is upwardly bent in a round shape, any impact that may occur when the coin 1 contacts the first arm 55a is reduced. Since the first arm 55a is hung down at a portion far away from the rotary shaft, the coin 1 contacts a longer guide rod 53 of the two guide rods 53 and 54 and at the same time contacts a top portion of the first arm 55a. Also, the first terminal 58a, as shown in FIG. 14, is disposed at the lowest portion and has no change.

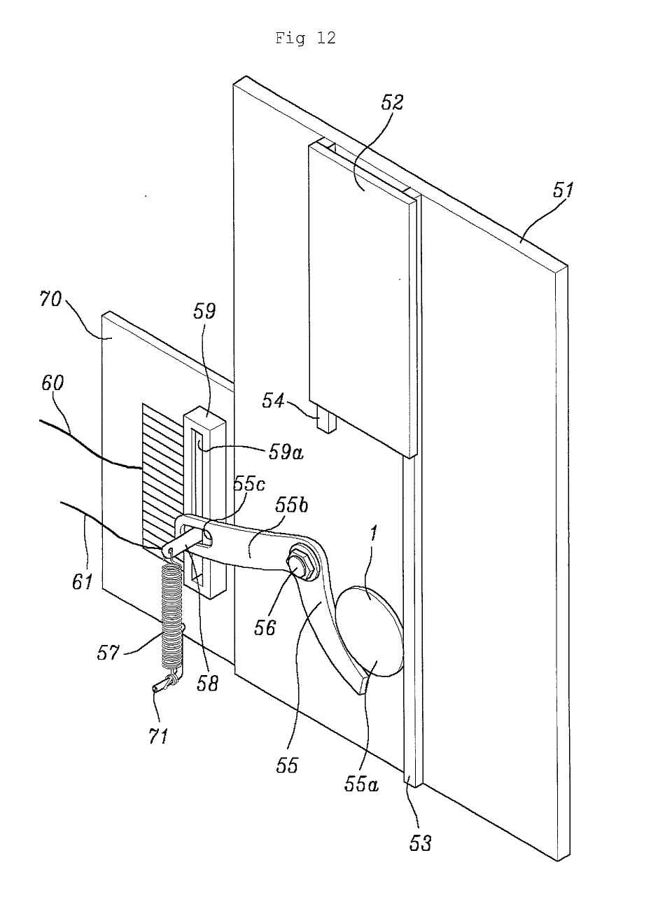

The coin 1 caught on the first arm 55a of the lever 55, as shown in FIG. 12, continues to move downwardly by departing from the elasticity of the spring 57 by means of its weight. At this time, the coin 1 is, of course, in contact with the first arm 55a and the longer guide rod 53. Meanwhile, the lever 55 is rotated and thus the second arm 55b is also rotated at the same angle as that of the lever 55 because the coin 1 moves downwardly while pushing the first arm 55a. Accordingly, the spring 57 connected to the rod 58 is elongated. At this time, the first terminal 58a, as shown in FIG. 15, is turned on/off together with the second terminals 60a while moving upwardly. In FIG. 15, the first terminal 58a is turned on/off five times. Once the first terminal 58a is turned on/off, its signal starts to be input to the controller 12 through the cables 60 and 61.

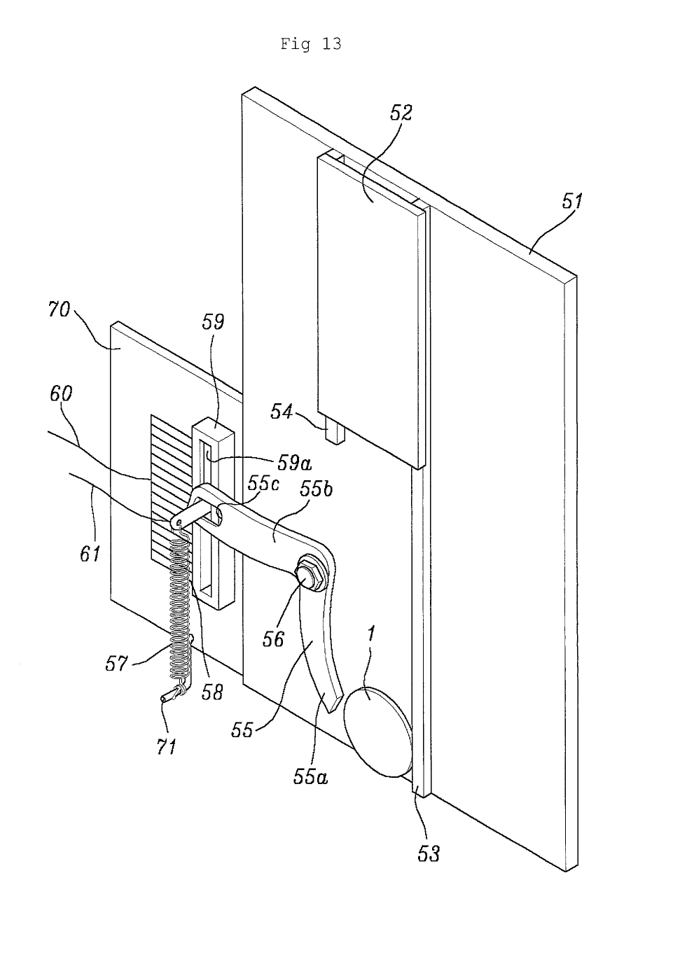

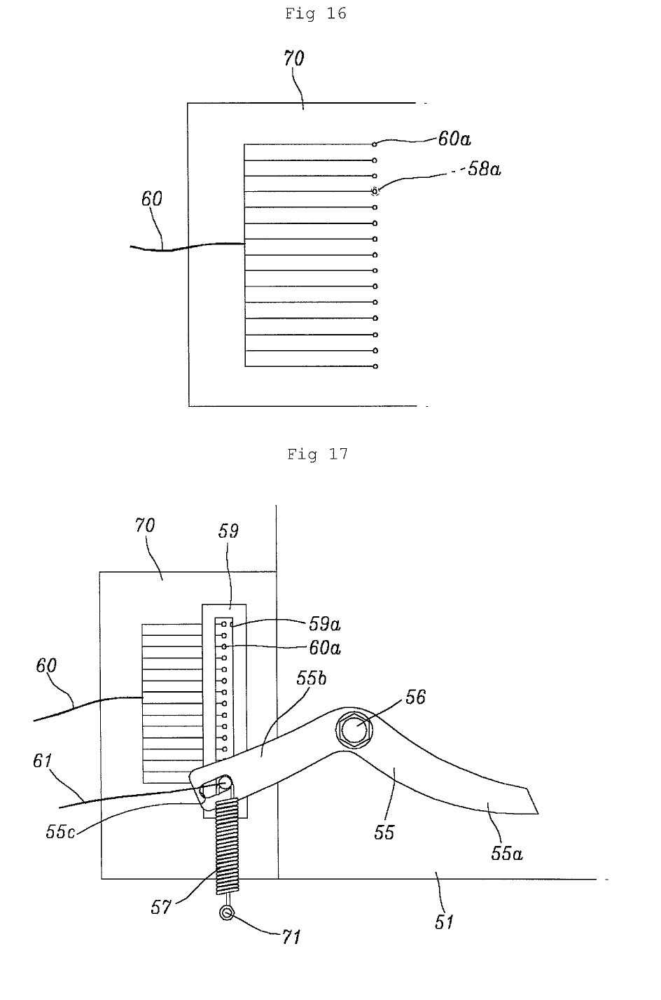

Once the coin 1 departs from the first arm 55a as shown in FIG. 13 as it continues to descend, the lever 55 is rotated clockwise so that the distance between the end of the first arm 55a and the guide rod 53 becomes greater than a diameter of the coin 1, thereby completely descending the coin 1. At this time, the spring 57 is more elongated than the state of FIG. 12, and the second arm 55b is also rotated at a greater angle. Therefore, as shown in FIG. 16, the first terminal 55a passes through twelve second terminals 60a, so that twelve on/off signals are input to the controller 12.

Afterwards, once the coin 1 departs from the lever 55 to descend, the coin 1 descends in the saving box 1. The lever 55 returns to its original position by rotating counterclockwise by means of the elasticity of the spring 57, as shown in FIGS. 11 and 17. The rod 58 of the first terminal 58a is fitted into the slot 59a of the guide cover 59 to move up and down in a straight-line direction. At the same time, since the rod 58 is also fitted into the slot 55c of the second arm 55b of the lever 55, interference occurs between the two slots 55c and 59a. To remove the interference, as shown in FIG. 17, the slot 55c formed in the second arm 55b of the lever 55 has a longer length. Thus, if the rod 58 of the first terminal 58a is disposed at the lowest original portion, it is disposed at the right of the slot 55c and moves to the left of the slot 55c as the first terminal 58a moves upwardly.

As described above, once the coin 1 having a certain diameter descends and thus the first terminal 58a is turned on/off several times while contacting a certain number of the second terminals 60a, a signal of the first terminal 58a is input to the controller 12. Thus, the controller 12 can sense the size of the coin 1 by means of the input signal. Then, the controller 12 determines the amount of the coin corresponding to the size of the coin by means of a previously set program. Therefore, the controller 12 can calculate the accumulated amount of the coins saved in the saving box in accordance with the input signal. Meanwhile, to sense the size of the coin and its amount, the first terminal is turned on/off twelve times in case of the size of the coin illustrated in the embodiment, it is turned on/off less than twelve times in case of the coin having a smaller size, and it is turned on/off greater than twelve times in case of the coin having a greater size.

As aforementioned, the saving box according to the present invention has advantages in that a simple contact terminal is mechanically installed to check the amount of the coins inserted in the saving box and also to check whether the coins have been completely inserted therein.

The foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A saving box which senses an amount of coins inserted in a coin slot and accumulatively calculates the amount of the coins so that a controller automatically opens a door to drawn out the coins if the accumulated amount reaches a target amount, the saving box comprising:
a guide means connected to the coin slot to guide the coins descending by tare;
a lever guided by the above said guide means and rotated by load of the descending coins, having a first terminal electrically connected to the controller;
a plurality of second terminals electrically connected to the first terminal of the lever as the lever rotates and each electrically connected to the controller; and
an elastic means providing restoring force to allow the lever to return to its original position after the lever rotates.

2. The saving box of claim 1, wherein the guide means includes a panel on which a rotary shaft of the lever is installed, two guide rods fixed to the panel at a greater distance than a diameter of the coin to guide the coin to the lever, and a cover panel covering a portion between the guide rods.

3. The saving box of claim 1, wherein the lever includes a first arm and a second arm, each arm being installed as to rotate at the same angle to the rotary shaft, the coin being caught in the first arm around the rotary shaft, the first terminal of the lever being installed in the second arm, and the first arm being bent downwardly in a round shape to reduce impact when the coin contacts the first arm.

4. The saving box of claim 1, wherein the second terminals are installed along the same radius as that of the first terminal around the rotary shaft of the lever so that it can contact the first terminal of the lever.

5. The saving box of claim 1, wherein the second terminals are installed in a line, and includes a guide cover installed to cover the second terminals, the guide cover having a slot formed to guide the first terminal of the lever in a straight-line direction, and the lever having a slot into which the first terminal is fitted to move in a straight-line direction.

6. The saving box of claim 1, further comprising a sensor connected to the controller to sense whether the coin has completely passed through the lever.

7. The saving box of claim 6, wherein the sensor includes a first contact node elastically bent when the coin is inserted in the saving box, and a second contact node connected with the first contact node when the first contact node is bent, thereby resulting in that the controller senses the coin.

8. The saving box of claim 1, further comprising a catcher installed in a case, a bolt installed in the door and linearly driven to be caught in the catcher, an elastic means which provides elasticity to pull the bolt in an opposite direction of the catcher, and a fixed means fixing the bolt in a state that the bolt is caught in the catcher.

9. The saving box of claim 8, wherein the fixed means includes a hanging member hung in a step portion formed at one side of the bolt and made of a magnetized material, and an electromagnet releasing the hanging member from the step portion to backwardly move the bolt by means of the elastic means.

10. The saving box of claim 8, wherein the elastic means is a tension spring.
